(19) United States
(12) Patent Application Publication
(10) Pub. No.: US 2012/0218756 A1
(43) Pub. Date: Aug. 30, 2012

(54) Lighting Device Comprising a Bulb

(76) Inventors: Ralph Bertram, Nittendorf (DE); Moritz Engl, Regensburg (DE); Simon Schwalenberg, Donaustauf (DE)

(21) Appl. No.: 13/505,994

(22) PCT Filed: Oct. 27, 2010
(86) PCT No.: PCT/EP10/66252

§ 371 Date: May 3, 2012

(30) Foreign Application Priority Data
Nov. 3, 2009 (DE) 10 2009 051 763.4

(51) Int. Cl. F21V 7/00; F21V 21/00

(52) U.S. Cl. 362/235; 362/249.01; 362/249.02

(57) ABSTRACT

A lighting device (1) comprising at least one light source (7), at least one at least partially transparent bulb (4) at least partially surrounding the at least one light source (7), and at least one base (2) for mechanically holding and electrically contacting the lighting device (1), wherein the bulb (4) at least partially features a plurality of plane sections (5) on at least one surface (11, 12) of the bulb (4).

### TECHNICAL FIELD

The invention relates to a lighting device comprising at least one light source, at least one at least partially transparent bulb at least partially surrounding the at least one light source, and at least one base for mechanically holding and electrically contacting the lighting device.

### PRIOR ART

Lighting devices of this type are used as so-called retrofit lamps for the purpose of replacing conventional incandescent lamps. The bulb is no longer used to protect the filament in this case, but is essentially for decorative purposes and/or directing the light. In the context of this application, a light source is therefore considered to be a device which is suitable for generating light and can be used continuously (i.e. at least for a plurality of hours) for general lighting purposes without further protective measures (i.e. a light source that also functions without a bulb, unlike the incandescent filament of an incandescent lamp). Since a transparent bulb allows the internal light source (e.g. the discharge vessel of a florescent lamp or light-emitting diodes) to be seen, thereby destroying the illusion of an incandescent lamp, these bulbs are generally frosted in order to simulate the impression of a frosted incandescent lamp.

The diffuse light effect of a frosted lamp is however undesirable in many applications, e.g. for use in a light fitting that comprises light-refracting elements such as a crystal chandelier, for example, wherein the observer is used to noticing both the incandescent filament itself, as a relatively concentrated light source within the glass bulb of the incandescent lamp, and a multiplicity of white and/or colored reflexes and light spots as a result of the refraction of the light on the crystal decorations of the chandelier, wherein these reflexes and light spots can change significantly due to a slight change in the perspective and/or viewing angle of the observer (sparkling, brilliant). When frosted lighting means are used, in particular the color play of the diffracted light is significantly reduced due to the now surface-like light emission of the lamps.

### STATEMENT OF THE INVENTION

The present invention therefore addresses the problem of creating a lighting device in accordance with the preamble of the main claim, wherein said lighting device causes a particularly brilliant and sparkling lighting impression, in particular when used in light fittings that comprise light-refracting elements. In particular, it is intended to provide a replacement for clear-glass candle-shaped incandescent lamps.

This problem is solved by the characterizing features in claim 1.

Particularly advantageous embodiments are specified in the dependent claims.

By virtue of the bulb at least partially featuring a plurality of plane sections on at least one surface of the bulb, faceting is achieved at least in partial regions of the bulb; this results in narrowly delimited regions in which the light emerges from the bulb, while the adjacent region appears considerably darker. The light typically emerges approximately unidirectionally, and the main emission directions of the individual regions clearly differ from each other. As a result of this, firstly the desired sparkling brilliant impression is achieved directly at the lighting device, and secondly a surface-like light emission is avoided, such that this effect is also amplified in the light-refracting elements of a light fitting, for example, unlike lighting devices which comprise frosted bulbs. A plurality of plane sections is considered to exist when more than 5 sections (and in particular more than 10 sections) are present.

It is particularly advantageous if the plane sections are arranged on the outer side and on the inner side of the bulb. The faceting is therefore realized on both the arrival side and the emergence side of the bulb, and the effect is amplified in comparison with faceting on a single side only.

This applies in particular if the planes of at least one of the plane sections on the outer side and of at least one of the plane sections on the opposing, inner side are so arranged as to be parallel with each other. It is particularly easy to specify the beam direction in these regions. An arriving light beam re-emerges practically parallel with the original beam path. Such an arrangement is particularly advantageous if a plurality of sections, particularly adjacent sections, are arranged thus, since the bulb then features a constant wall thickness over large surface areas, thereby simplifying the manufacture, for example.

The plane sections advantageous have a surface area of between 1 mm² and 100 mm², and most preferably between 5 mm² and 50 mm².

In a further advantageous development of the invention, the bulb features at least one reflective particle, in particular a plurality of reflective particles. Such particles are particularly suitable for already generating the desired sparkle in the region of the light source by means of locally delimited reflexes. A bulb is also conceivable in which the desired brilliant effect is primarily generated by the particles, and which therefore only features a few plane surface areas on the outer and inner contours.

In an appropriate embodiment, the reflective particles are essentially made of a metal. Metals usually have a high degree of reflectivity, allow simple manufacture and processing of the particles, and the light color of the reflected light can be influenced depending on the type of metal used. It is important in this context that the surface should remain metallically blank during the course of manufacture, wherein this can be dependent on the bulb material that is used and on the process that is used for the embedding. In addition to metals and alloys that are based on iron, aluminum or nickel, which tend to reflect a white light, possible options also include metals and alloys such as copper and/or brass, which reflect light in the red or yellow wavelength range instead.

A further advantage of using metals is their generally relatively high melting point, such that dimensional stability is assured during processing even in the case of high temperatures, in contrast with the use of polymer materials.

In a further appropriate development of the invention, the reflective particles are formed by a main body with a reflective coating. It is thereby possible to achieve a similar effect to that achieved using metal particles. By means of suitably selecting the main body and the coating, the properties can advantageously be adapted to the intended purpose, such that e.g. the thermal expansion coefficient of the particles is as close as possible to that of the bulb. The particles can also be only partially coated, thereby allowing both reflection and refraction of the incident light, particularly in the case of transparent particles.

In a further development of the invention, the bulb features at least one particle which has a refractive index that differs from the refractive index of the bulb, in particular a plurality of particles having a refractive index that differs from the refractive index of the bulb. This results in a refraction or total reflection of the incident light at the boundary surface areas between particles and bulb, and the incident light beam can be diverted in its direction, thereby producing a unidirectional emission which creates the desired sparkle effect.

If the particles (which have a refractive index that differs from the refractive index of the bulb) are essentially formed of a polymer material, they are particularly easy to manufacture and process. When using a bulb of a polymer material, the difference in the thermal expansion between particles and bulb is very slight, thereby avoiding the development of thermal tensions, which can adversely affect e.g. the emission characteristics of the bulb (tension reams).

If the particles (which have a refractive index that differs from the refractive index of the bulb) are essentially formed of glass, said particles can also be used at higher processing temperatures, e.g. when using a glass bulb. In this case, the thermal mismatch between particles and bulb is also sufficiently slight. Glass also has a relatively high refractive index, which amplifies the desired sparkle effect.

If the particles (which have a refractive index that differs from the refractive index of the bulb) are essentially formed of a ceramic material, said particles can also be used at higher processing temperatures, e.g. when using a glass bulb. Ceramics (e.g. aluminum oxide or zircon oxide) also have a relatively high refractive index, which amplifies the desired sparkle effect.

If the reflective and/or light-refracting particles likewise feature plane surface areas on sections of their surface, the output of reflected and/or diffracted light beams likewise becomes very strongly directional and therefore amplifies the desired sparkling light effect of the lighting device.

In an appropriate embodiment, the bulb is essentially made of a polymer material. Polymer materials can be manufactured simply and inexpensively, and can also be made into complicated shapes with little effort. They also have a smaller thickness than glass, and therefore the bulb is relatively light. The processing takes place at low temperatures, this likewise being advantageous.

In a further advantageous development of the invention, the bulb is essentially made of glass. Glass generally has a relatively high refractive index in comparison with polymer materials, thereby increasing the desired sparkle effect as a result of the enhanced effect of the faceting. Furthermore, glass is highly resistant to scratches and its optical properties are less sensitive to temperature fluctuations or differences than a polymer material.

According to a further advantageous development of the invention, the bulb is essentially made of a ceramic material. Ceramic materials such as e.g. aluminum oxide or zircon oxide generally have a relatively high refractive index in comparison with polymer materials, thereby increasing the desired sparkle effect as a result of the enhanced effect of the faceting. Furthermore, they are highly resistant to scratches and their optical properties are less sensitive to temperature fluctuations or differences than a polymer material.

It is also advantageous if the bulb features a lens structure on the inner side, at least in sections. The lenses allow a very selective configuration of the light distribution to be effected. In particular, each plane section on the outer surface of the bulb can be assigned a lens on the inner side. The directing of light is therefore optimized for each plane section, and unidirectional emission can be achieved, for example.

Provision is advantageously made for arranging at least one reflector within the bulb. This allows the emission properties of the lighting device to be optimized by selectively directing the light. A reflector can advantageously be used to direct e.g. part of the light in a different direction, particularly when light-emitting diodes featuring unidirectional emission are used as a light source.

The reflector is advantageously designed in approximately the shape of a cone and/or pyramid. Such a shape is particularly suitable for lateral redirection of a unidirectional beam which strikes the tip of the cone or pyramid, thereby achieving an approximately uniform all-round emission assuming a suitable arrangement (in particular assuming a unidirectional beam coming from the light source).

In order to achieve this, the reflector is advantageously arranged in the region of the apsis of the bulb. This is advantageous in particular if the light source is arranged at the opposite end of the bulb, i.e. in the region of its base, in order at least partially to laterally deflect the light arriving from there.

If the reflector is so designed as to be partially transparent, at least in sections, for at least a partial range of the spectrum of visible light, an even more uniform distribution of the light can be achieved because said light is now both reflected and transmitted. If the reflector is only transparent for partial ranges of the spectrum, coloration can be achieved for both the reflected and the transmitted light. This can likewise be perceived as pleasing to the observer, since e.g. the crystal decorations of the chandelier can also generate such colored reflexes.

Particularly favorable emission characteristics are likewise achieved if the reflector at least partially features a plurality of plane sections, i.e. a facetted structure at least in sections, since the desired sparkling effect already occurs at the reflector in this case. This is advantageous in particular if sections of the bulb do not feature any faceting, since the facet effect of the reflector is present there. The effect is further amplified when facetted regions of the bulb are penetrated.

Reflector and bulb are advantageously designed as a unitary part. This simplifies the manufacture, since the resource-intensive connection of bulb and reflector is unnecessary and the exact positioning of the reflector in the bulb is assured.

It is likewise advantageous if at least one reflector is arranged in the region of the light source. The closer the reflector is arranged to the light source, the smaller it can be if the same portion of the light leaving the light source is to be reflected. The losses due to scattered light etc. are also minimized in this way.

It is moreover advantageous if the bulb features at least one reflector in the vicinity of the light source. The attachment of the reflector to the bulb is advantageous in terms of manufacturing, and can provide an advantageous distribution of light, particularly in the case of a laterally emitting light source.

If the reflector is embodied at least partially as a reflective coating of the bulb, a particularly simple implementation is achieved as a coating can be deposited using simple means and the manufacture of the lighting device is therefore simplified.

It is moreover advantageous if the light source is so designed as to be variable in respect of its characteristic lighting values, in particular brightness and/or color and/or emission angle. In this way, the impression of rapidly varying lighting (which is characteristic of the desired “sparkling”) can be generated as soon as the light comes on.

It is likewise appropriate for the light source to comprise at least one light-emitting diode. Light-emitting diodes are compact, energy-saving and, depending on the development, can be extensively adjusted in terms of their lighting parameters.

In an advantageous development of the invention, the main emission direction of at least one LED is so orientated as to be perpendicular to the longitudinal axis of the lamp. It is therefore possible to achieve a stronger lateral emission, wherein this can be advantageous particularly for use in a chandelier, since further light-refracting or reflective elements of the chandelier tend to be arranged to the side rather than above the lamp.

It can be generally advantageous if the main emission direction of the light source does not run parallel with the longitudinal axis of the lamp, since it is likewise possible thus to achieve a stronger lateral emission, wherein this can be advantageous particularly for use in a chandelier, since further light-refracting or reflective elements of the chandelier tend to be arranged to the side rather than above the lamp.

### BRIEF DESCRIPTION OF THE DRAWINGS

The invention is explained in greater detail below with reference to exemplary embodiments. Identical parts or parts having identical effect are denoted by means of identical reference signs. The illustrations in the figures are not necessarily to scale and individual dimensions or dimensional ratios may be shown in a modified or distorted manner in order to aid understanding, wherein:

FIG. 1 shows a lighting device according to the invention,

FIG. 2 shows a lighting device according to the invention in a sectional view,

FIG. 3 shows a second exemplary embodiment of a bulb of a lighting device according to the invention in a sectional view,

FIG. 4 shows a third exemplary embodiment of a bulb of a lighting device according to the invention in a sectional view,

FIG. 5 shows a fourth exemplary embodiment of a bulb of a lighting device according to the invention in a sectional view,

FIG. 6 shows a fifth exemplary embodiment of a bulb of a lighting device according to the invention in a sectional view,

FIG. 7 shows a further exemplary embodiment of a lighting device according to the invention in a sectional view.

### PREFERRED EMBODIMENT OF THE INVENTION

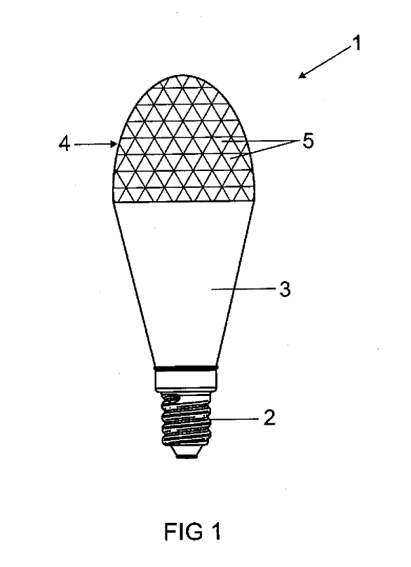

FIG. 1 shows a lighting device 1 according to the invention in a side view. A so-called retrofit lamp 1 is shown, i.e. a lighting device 1 that can be used in a standardized socket instead of a conventional incandescent lamp. Such lamps are intended to externally resemble an incandescent lamp as closely as possible, and therefore in addition to the standardized base 2 and a mounting piece 3, which is designed as a heat sink 3 here, provision is made for a bulb 4 that covers the actual light source. Unlike an incandescent lamp, where the bulb is fundamental to the function thereof, the bulb in retrofit lamps merely has, in addition to a decorative effect, the function of providing a protection of the light source against mechanical influences and a means of directing the beam. In contrast with the LED retrofit lamps disclosed in the prior art, in which the bulb is generally made of an opaque material, the bulb 4 shown in the exemplary embodiment is made of a transparent material. However, it features numerous plane sections 5 on its surface, thereby resulting in a facetted structure. The interior of the bulb 4 therefore remains hidden from the observer, at least from the normal viewing distance, this being advantageous in consideration of the preferred use of such an LED retrofit lamp 1 in open light fittings, in particular in chandeliers, since it is intended in these applications to give the impression of a light fitting that features candles or at least incandescent lamps, and this is not guaranteed if the LEDs (not shown) that are arranged on printed circuit boards (also not shown) are clearly visible.

In this case, the size of the plane sections 5 is selected such that it is large enough to avoid the impression of a frosted surface yet small enough to avoid the impression of a transparent bulb 4, and in particular such that from a normal viewing distance it is not possible to see through the bulb 4 and the interior is recognizable in a fragmented way at best. The size range of the plane sections is advantageously between 1 mm² and 100 mm², and most preferably between 5 mm² and 50 mm².

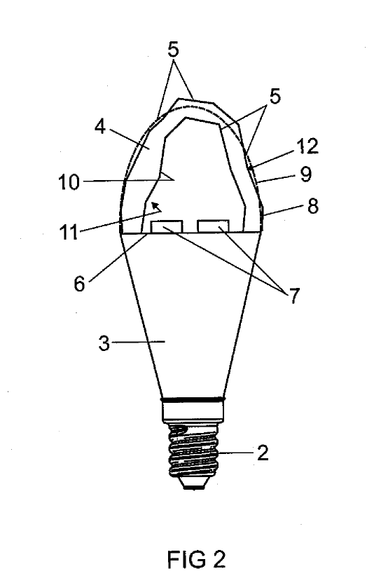

FIG. 2 shows the lighting device 1 as per FIG. 1 in a sectional view. Arranged on the standardized base 2 is the mounting piece 3, which is designed as a heat sink 3 in the present exemplary embodiment. Arranged on the heat sink 3 is a mounting circuit board 6, to which are attached light-emitting diodes (LEDs) 7 and the bulb 4 that surrounds said light-emitting diodes 7. The LEDs 7 in the present exemplary embodiment have Lambertian emission characteristics, but other embodiments are also conceivable.

Arranged in the interior of the heat sink 3 is an electronic circuit (not shown), which is used to supply voltage and optionally for activation of the LEDs 7.

In terms of its external contour 8, the bulb 4 is modeled on the shape of a conventional incandescent lamp, the average deviations from a contour 9 that is similar or identical to an incandescent lamp being in particular equal to zero on average. Instead of the continuously rounded shape of an incandescent lamp, the bulb 4 is however divided into individual plane sections 5 which can be recognized as straight lines in the sectional view. In the present exemplary embodiment, the internal contour 10 of the bulb 4 and the external contour 8 of the bulb 4 are constructed entirely of such plane sections 5. However, the plane sections 5 on the inner side 11 and on the outer side 12 do not necessarily feature plane-parallel surface areas, are not necessarily identical in their extent, and do not necessarily differ solely in the dimension that is produced as a result of the larger surface of the external contour 8 relative to the internal contour 10. This results in emission characteristics that feature distinct maxima in specific spatial directions, even if when averaged over larger regions (typically in the order of 0.5 sr to 1 sr) in the half-space above the mounting board 6 these regions all have an identical luminance.

The bulb 4 in the present exemplary embodiment is made of glass, which leaves a particularly brilliant impression on an observer, particularly if the plane surface areas are manufactured by grinding and therefore have particularly sharp edges. However, other embodiments and materials are conceivable for the bulb 4, making use in particular of polymethyl methacrylate (PMMA), polycarbonate or other transparent thermoplastic synthetic materials, epoxy resin or other duroplastic synthetic materials, or silicone. Likewise when selecting the glass, a person skilled in the art will be familiar with a plurality of possibilities, in particular those which have been tried and tested in optical and/or light-related applications

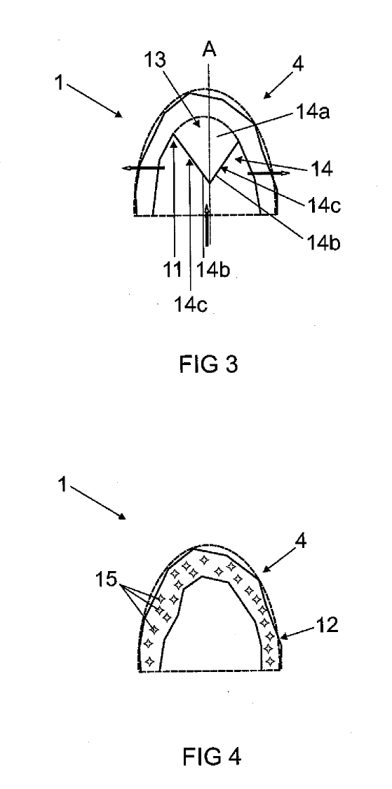

FIG. 3 shows a second exemplary embodiment of a bulb 4 of a lighting device 1 according to the invention. In this configuration, the bulb 4 has a reflector 14 at its apsis 13 on the inner side 11. The reflector 14 is conical in shape and its main body 14a is an integral part of the bulb 4. The side walls 14b are embodied at an angle of approximately 45° relative to the longitudinal axis A of the lamp, such that most of the light that strikes them (arrow direction) is output at an angle of approximately 90° relative to the longitudinal axis A of the lamp.

In order to achieve the reflective properties, the main body 14a is equipped with a reflective layer 14c. Provision is made for a completely reflective layer 14c, which clearly reduces the emission of light upwards. This can be desirable if the LED lamp 1 is held e.g. upright in a chandelier, i.e. with the bulb 4 upwards, but the light is to be output mainly to the side or even downwards. Such a reflector 14 can also be advantageous in the context of an installation in an opposite orientation, in order to prevent glare directly downwards. However, embodiments are also conceivable in which the reflector 14 is shaped differently, e.g. as a pyramid or with facets. It is likewise conceivable for the reflector 14 to be installed in the bulb 4 as an independent part, e.g. by means of adhesion, screws or shrink-fit means, by means of a clamped joint, snap-on or snap-in connection, or using other connection techniques known to a person skilled in the art. It is likewise conceivable for the reflector 14 to be partially transparent, i.e. it does not completely reflect the light that strikes it. Furthermore, it is conceivable for the reflection properties to be dependent on wavelength, i.e. only a partial range of the striking spectrum passes through or is reflected. The color impression of the lighting device can therefore be different in different directions, thereby producing a very harmonious overall image when used in chandeliers having crystal decorations in particular, where an appearance similar to that of refraction on the decorations can be achieved.

FIG. 4 shows a third exemplary embodiment of a bulb 4 of a lighting device 1 according to the invention, the bulb 4 in this case consisting of a transparent polymer material and containing reflective particles 15. The sparkling is amplified by the particles 15, since these likewise emit the striking light at a highly localized position and in a narrowly delimited solid angle. The reflective metal particles 15 in the present exemplary embodiment are essentially made of aluminum, uniformly distributed and shaped like flakes. Other embodiments are also conceivable, however, e.g. made of a pure metal or an alloy based on e.g. iron, copper, nickel, aluminum, silver or gold. A range of possibilities will be known to a person skilled in the art, who will make a selection according to reflective properties, processing characteristics, color, costs and other criteria. It is likewise conceivable to use particles 15 that are equipped with a fully or partially reflective layer, wherein these can be made from any material that is suitable for incorporation in the bulb 4. The size of the particles 15 is appropriately in a range of between 0.1 mm and 5 mm, wherein the selection is based on the desired effect (weak or strong glittering) and on the thickness of the bulb 4. It is also conceivable for the particles 15 to be only partially enclosed in the bulb 4, though penetration through the outer side 12 is usually only considered advantageous in exceptional cases (e.g. in the case of particles which have less sharp edges and allow the lamp 1 to be grasped securely without slipping) due to the risk of injury to the user, for example. The distribution of the particles 15 within the bulb 4 is approximately uniform, though embodiments can also exist in which the particles 15 have varying local distribution densities.

FIG. 5 shows a fourth exemplary embodiment of a bulb 4 of a lighting device 1 according to the invention, in which the bulb 4 of the LED lamp 1 again contains reflective particles 15. Also arranged in the apsis 13 of the bulb 4 is a partially transparent reflective element 14, which is designed to be an integral part of the bulb 4 as in the exemplary embodiment from FIG. 3. In this exemplary embodiment, a large portion of the light is therefore emitted laterally and is also deflected on the reflective particles 15, thereby producing a very brilliant and sparkling impression when seen from the side in particular.

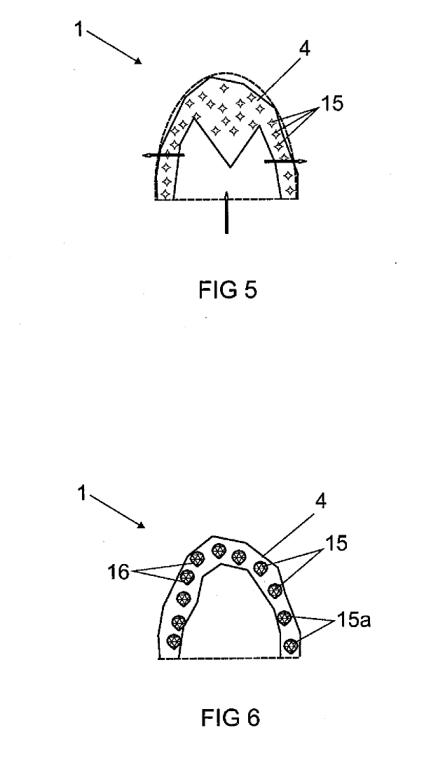

FIG. 6 shows a fifth exemplary embodiment of a bulb 4 of a lighting device 1 according to the invention. Incorporated into the bulb 4 in this case are particles 15 which are per se transparent, but which have a refractive index that is different to that of the material of the bulb 4. The particles 15 are embodied as polyhedrons, as so-called prismatic balls in this case, having plane surface areas 15a. This produces a facetted effect of the individual particles 15, in the same way as the effect of the bulb 4. In particular, this can result in total reflections at the boundary surface areas 16. For the purpose of manufacturing such a bulb 4, an appropriate embodiment provides for the particles 15 to have a considerably higher melting and/or softening point than the material from which the bulb 4 is made. They are therefore preserved during the manufacturing process of the bulb 4, wherein said process usually involves heating which is not inconsiderable.

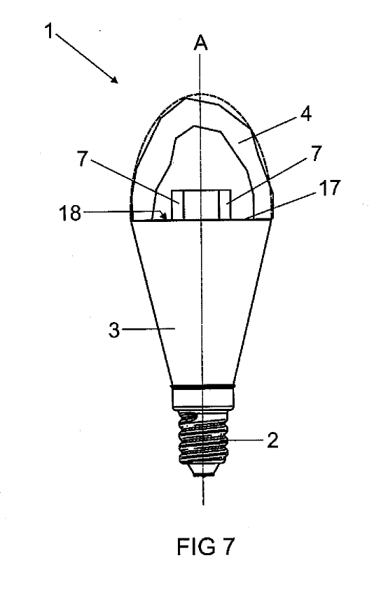

FIG. 7 shows a further exemplary embodiment of a lighting device 1 according to the invention in a sectional view, wherein the basic structure of the bulb 4 and the heat sink 3 is of similar design to that shown in FIG. 2, but the LEDs 7 are arranged in such a way that their main emission direction is not parallel with the longitudinal axis A of the lighting device 1. In the present exemplary embodiment, the emission direction lies at an angle of approximately 90° relative to the longitudinal axis A. It is consequently possible using particularly simple means to achieve a stronger emission laterally than in a longitudinal direction A of the lighting device 1, this being advantageous in certain application scenarios as mentioned above. In this context, provision is appropriately made for the surface 17 of the heat sink 3 also to feature a reflective layer 18, such that it acts as a reflector in order that any light which strikes it can be utilized to the fullest extent.

Further embodiments of the invention are naturally also conceivable. In particular, the LEDs 7 can be equipped with a primary lens system for the purpose of beam direction. For this purpose, it is also conceivable to arrange a reflector around an LED 7 or a plurality of LEDs 7 together. It is also possible to arrange reflectors, either as separate components or as an integral part of the bulb 4, at locations other than those shown in the exemplary embodiments. In particular, it can be appropriate to attach a reflector, e.g. in the form of a coating or as a separate component, in the lower region of the bulb 4, where it is connected to the heat sink 3. This causes a larger portion of the light to be emitted upwards in the longitudinal direction A of the lighting device 1, this being desirable for many application fields.

The sparkling effect can also be amplified by the activation of the LEDs 7, particularly if a plurality of these are installed in the lighting device 1, by switching them on and off or changing their brightness and/or color in a predetermined manner or at random.

It is obviously possible to conceive of structural shapes other than those shown in the exemplary embodiments, particularly if different bulb shapes or different bases are used. In particular, the design of the plane surface areas of the bulb 4 can differ quite significantly from the exemplary embodiments. It is thus possible to conceive of embodiments wherein plane surface areas 5 are featured solely on the external contour 8 of the bulb 4, which can provide e.g. manufacturing-related advantages, or solely on the internal contour 10, whereby the external appearance of the bulb 4 resembles that of a conventional incandescent lamp, or even bulbs 4 wherein the plane regions 5 on the internal contour 10 are arranged at partially or wholly different areas of the bulb 4 to those on the external contour 8.

The heat sink 3 itself can also be provided wholly or partially with a reflective coating, such that the sparkling impression is also produced in the case of incident light from other light sources, e.g. from other lamps included in a chandelier.

The design of the reflector 14 in the apsis 13 of the bulb 4 can also vary from the exemplary embodiments shown here, both in respect of the degree of reflectivity for individual wavelengths and/or the entire spectrum, and in respect of the shape. Pyramid-type shapes are particularly appropriate here, wherein any desired regular or irregular polygon is possible as a shape for the base and/or the sectional planes. The edges likewise do not have to run in straight lines in this case, but can vary their angle of inclination continuously or discontinuously, for example.

Also conceivable are rotationally symmetrical shapes having contours that are different than the straight contours shown, e.g. paraboloids or hyperboloids of rotation.

1. A lighting device comprising at least one light source, at least one at least partially transparent bulb at least partially surrounding the at least one light source, and at least one base for mechanically holding and electrically contacting the lighting device, wherein the bulb at least partially features a plurality of plane sections on at least one surface of the bulb.

2. The lighting device as claimed in claim 1, wherein the plane sections are arranged on the outer side and on the inner side of the bulb.

3. The lighting device as claimed in claim 1, wherein the planes of at least one of the plane sections on the outer side and of at least one of the plane sections on the opposing, inner side are so arranged as to be parallel with each other.

4. The lighting device as claimed in claim 1, wherein the bulb features at least one reflective particle.

5. The lighting device as claimed in claim 1, wherein the bulb features at least one particle which has a refractive index that differs from the refractive index of the bulb.

6. The lighting device as claimed in claim 1, wherein the bulb features a lens structure on the inner side, at least in sections.

7. The lighting device as claimed in claim 1, wherein at least one reflector is arranged within the bulb.

8. The lighting device as claimed in claim 7, wherein the reflector is arranged in the region of the apsis of the bulb.

9. The lighting device as claimed in claim 7, wherein the reflector is so configured as to be partially transparent, at least in sections, for at least a partial range of the spectrum of visible light.

10. The lighting device as claimed in claim 7, wherein the reflector at least partially features a plurality of plane sections.

11. The lighting device as claimed in claim 7, wherein the reflector and bulb are configured as a unitary part.

12. The lighting device as claimed in claim 7, wherein at least one reflector is arranged in the region of the light source.

13. The lighting device as claimed in claim 1, wherein the light source is configured to be variable in respect of its characteristic lighting values.

14. The lighting device as claimed in claim 1, wherein the light source comprises at least one LED.

15. The lighting device as claimed in claim 1, wherein the main emission direction of at least one LED is so oriented as to be perpendicular to the longitudinal axis of the lighting device.

16. The lighting device as claimed in claim 1, wherein the light source is configured to be variable in respect of brightness and/or color and/or emission angle.
